(19) United States
(12) Patent Application Publication
(10) Pub. No.: US 2007/0241097 A1
(43) Pub. Date: Oct. 18, 2007

(54) Atomic oscillator, method for sealing temperature detecting means, and rubidium atomic oscillator

(75) Inventors: Tsunenori Shibata, Fujisawa-shi (JP); Koji Chindo, Kawasaki-shi (JP)

Correspondence Address: OLIFF & BERRIDGE, PLC, P.O. BOX 19928, ALEXANDRIA, VA, 22320, US

(73) Assignee: EPSON TOYOCOM CORPORATION, TOKYO (JP)

(21) Appl. No.: 11/730,897

(22) Filed: Apr. 4, 2007

(30) Foreign Application Priority Data
Apr. 14, 2006 (JP) 2006-111868

(51) Int. Cl. H05B 1/02

(52) U.S. Cl. 219/492

(57) ABSTRACT

An atomic oscillator includes: a gas cell encapsulating a rubidium atom; a gas cell holding member holding the gas cell; a rubidium lamp exciting the rubidium atom in the gas cell; a lamp holding member holding the rubidium lamp; a temperature detecting means disposed in a recessed part provided to at least one of the gas cell holding member and the lamp holding member; and grease closely contacting an exterior surface of the temperature detecting means disposed in the recessed part and burying the temperature detecting means therein.

### BACKGROUND

1. Technical Field

The present invention relates to an atomic oscillator, a method for sealing a temperature detecting means, and a rubidium atomic oscillator. More particularly, the invention relates to a method for sealing a temperature detecting means provided to a thermostat part of a rubidium atomic oscillator.

2. Related Art

A method shown in FIG. 5, for example, is known as a conventional method for controlling a temperature of thermal cylinders (holding members) holding a rubidium gas cell and a rubidium lamp respectively in an atomic oscillator of a rubidium gas cell system. The method detects heat 38 from a heater 34 by a temperature sensor 35 and negatively feeds a temperature data from the temperature sensor 35 back through an amplifier 37 to maintain the heater 34 at constant temperature. In the conventional art, as shown in FIGS. 6A to 6C, the temperature sensor 35 is inserted into a recessed part 44 having a predetermined depth and provided on part of a surface of the thermal cylinder 42, and the recessed part 44 is filled with high thermal conductive silicon rubber 40 so as to fix the temperature sensor 35. Such fixation structure increases sensitivity of the temperature sensor 35 when detecting the temperature of the thermal cylinder 42, reducing variation in temperature as much as possible.

JP-A-2000-155055 discloses a fluid temperature detector, for example. The fluid temperature detector is provided with a protective tube extending into a fluid through a wall face of a pipe, a container, an apparatus, and the like surrounding the fluid and a sheath tube housed in the protective tube. In the detector, a temperature detecting element is housed in the sheath tube correspondingly to the tip section of the protective tube. Powder such as metal powder fills between the temperature detecting element and the sheath tube. In addition, a nearly cylindrical space is formed between the protective tube and the sheath tube, and the space is filled with a liquid such as silicone oil, silicone grease, and the like having higher thermal conductivity than that of air so as to accelerate the heat transfer from the protective tube to the sheath tube.

However, the conventional method for fixing the temperature sensor with silicon rubber has problems as below. That is, as shown in FIG. 6A, if the recessed part 44 is filled with silicon rubber 40 after inserting the temperature sensor 35, air in the inner back of the recessed part 44 possibly remains as an air bubble 41 without being removed since the silicon rubber has a low fluidity. In this case, since the detecting surface of the temperature sensor 35 is exposed to the air bubble 41, the conductivity of heat from the thermal cylinder 42 extremely deteriorates to decrease the sensitivity of the sensor 35, losing an account to fill with the silicon rubber 40 having high thermal conductivity. In addition, since the silicon rubber 40 becomes clouded to lose its transparency when hardening, the state of the temperature sensor 35 in the recessed part 44 disadvantageously can not be checked with eyes from the opening side.

Further, in a case, as well, where the temperature sensor 35 is displaced in the hardening process of the silicon rubber 40 as shown in FIG. 6B, the air bubble 41 is possibly generated similarly to the above, as shown in an enlarged view of FIG. 6C.

Further, the conventional art of the above example has such problems that the temperature sensor has a complex structure to increase in cost and the shape thereof is predetermined to limit its installation sites.

### SUMMARY

An advantage of the present invention is to provide a method for sealing a temperature detecting means. In the method, a temperature sensor is structured to be simple and not to be exposed to air, improving temperature detection sensitivity thereof.

In addition, another advantage of the present invention is to provide a temperature sensor realized inexpensively by simplifying the structure thereof and made available without limiting its installation sites.

An atomic oscillator according to an aspect of the invention includes: a gas cell encapsulating a rubidium atom; a gas cell holding member holding the gas cell; a rubidium lamp exciting the rubidium atom in the gas cell; a lamp holding member holding the rubidium lamp; a temperature detecting means disposed in a recessed part provided to at least one of the gas cell holding member and the lamp holding member; and grease closely contacting an exterior surface of the temperature detecting means disposed in the recessed part and burying the temperature detecting means therein.

The gas cell encapsulating the rubidium atom and the rubidium lamp need to be maintained at constant temperature so as to stabilize an excitation of rubidium gas. Therefore, a thermal cylinder (holding member) holding each of the gas cell and the rubidium lamp is provided, and to the thermal cylinder, a heater heating the thermal cylinder and a temperature sensor (temperature detecting means) detecting a temperature of the thermal cylinder are provided. At this time, the aspect fills the recessed part provided to part of each holding member with the grease having good fluidity and buries a sensor detecting the temperature of the each holding member in the grease. This can increase the temperature detection sensitivity considerably and prevent generation of the air bubble (vacancy) at the periphery of the temperature sensor.

The grease may be high thermal conductive silicon grease.

In order to detect the temperature of the thermal cylinder with good responsiveness, it is important to conduct the heat of the thermal cylinder to the sensor as fast as possible. Therefore, the grease closely contacting the temperature sensor needs to have high thermal conductivity. Using high thermal conductive silicon grease having good fluidity can increase the thermal conductivity.

The grease may be high thermal conductive non-silicon grease.

The grease is not limited to silicon grease, but may be non-silicon grease as long as it has high thermal conductivity. Thus, the silicon grease has broad options.

An opening of the recessed part may be sealed with a sealing member.

The grease filling the recessed part does not harden due to its high fluidity, so that the opening needs to be sealed after filling the recessed part with the grease. Therefore, the aspect provides the sealing member sealing the opening of the recessed part.

The sealing member may be composed of high thermal conductive adhesive.

The grease mainly conducts the heat of the thermal cylinder to the sensor. Therefore, the sealing member contacting the grease preferably has high thermal conductivity so as to expand the conductive area.

The sealing member may be composed of thermal-resistant adhesive.

The thermal cylinder reaches extremely high temperature. Therefore, the adhesive sealing the grease needs to have at least thermal resistance so as not to transform or melt due to the heat.

The sealing member may be composed of a high thermal conductive lid member.

The sealing member is used so as to prevent the grease from leaking to the outside. Therefore, the lid fitting the opening of the recessed part may be prepared to seal the grease filling the recessed part. In the case, the lid is preferably made of high thermal conductive material.

The sealing member may be composed of a thermal-resistant lid member.

The thermal cylinder reaches extremely high temperature. Therefore, the lid member sealing the grease needs to have at least thermal resistance so as not to transform or melt due to the heat.

In a method for sealing a temperature detecting means of the aspect of the invention, after the recessed part is filled with the grease, the temperature detecting means is buried in the grease, and then the opening of the recessed part is sealed with the sealing member so as to prevent the grease from leaking.

The process of the method for sealing a temperature sensor of the aspect first fills the recessed part provided to the thermal cylinder with the grease. In this case, the quantity of the grease is arranged in advance not to overflow the recessed part. The sensor is next inserted to the grease, and then the opening of the recessed part is sealed with the sealing member. Such simple method can prevent generation of the air bubble in the recessed part and improve the responsiveness of the temperature sensor.

In the method, after the temperature detecting means is disposed in the recessed part, the recessed part is filled with the grease such that the grease closely contacts the exterior surface of the temperature detecting means, and then the opening of the recessed part is sealed with the sealing member so as to prevent the grease from leaking.

Another process of the method of the aspect first disposes the sensor in the recessed part provided to the thermal cylinder. In this case, the sensor should not contact the thermal cylinder. Next, the recessed part is filled with the grease such that the grease closely contacts the exterior surface of the sensor. In this case, the quantity of the grease is arranged in advance not to overflow the recessed part. Then the opening of the recessed part is sealed with the sealing member. Such simple method can prevent generation of the air bubble in the recessed part and improve the responsiveness of the temperature sensor.

A rubidium atomic oscillator of the aspect of the invention may include a temperature detecting means sealed in the recessed part by the above method; a heating means heating at least one of the gas cell holding member and the lamp holding member; and a temperature control means maintaining the heating means at a predetermined temperature based on a temperature data detected by the temperature detecting means. The temperature control means controls the heating means by a negative feedback system.

A thermostat part of the rubidium atomic oscillator of the aspect includes the sensor sealed by the method for sealing of the aspect, and the temperature control means. The temperature control means controls the heating means by the negative feedback system. Therefore the temperature of the thermostat part of the rubidium atomic oscillator can be accurately controlled with higher sensitivity, minimizing temperature variations.

### BRIEF DESCRIPTION OF THE DRAWINGS

The invention will be described with reference to the accompanying drawings, wherein like numbers reference like elements.

FIG. 1 is a block diagram showing a brief structure of a rubidium atomic oscillator of the present invention.

FIGS. 2A to 2C are schematic views showing a lamp thermal cylinder according to a first embodiment of the invention.

FIGS. 3A and 3B are schematic views showing a gas cell thermal cylinder according to the first embodiment of the invention.

FIG. 4 is a schematic view showing a recessed part sealed with a sealing member according to a second embodiment of the invention.

FIG. 5 is a schematic diagram showing a common concept of negative feedback.

FIGS. 6A to 6C are schematic views showing problems according to a conventional method for sealing a temperature sensor.

### DESCRIPTION OF EXEMPLARY EMBODIMENTS

Embodiments of the present invention will now be described with great circumstance with reference to the accompanying drawings. Note that elements, kinds, combinations, shapes, relative positions, and the like described in the embodiments do not limit the range of this invention, but are only examples unless the description gives a special statement.

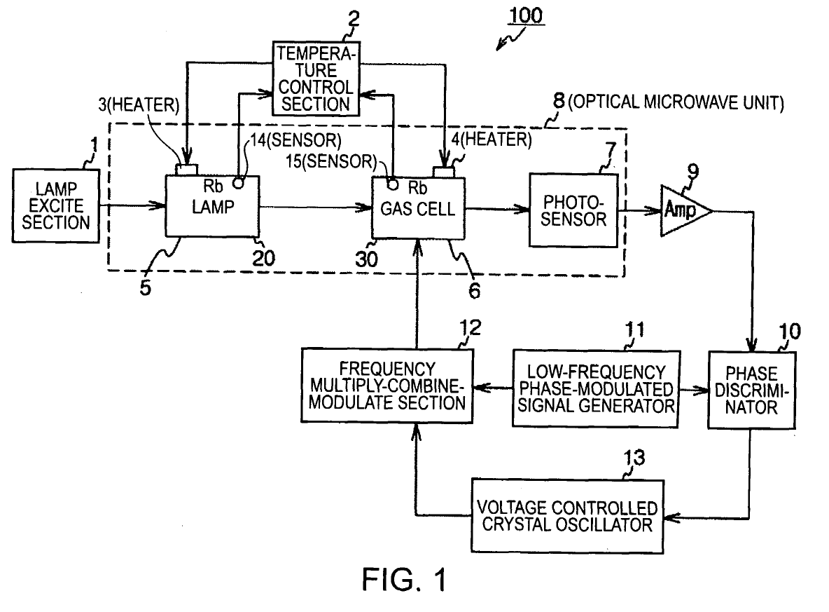

FIG. 1 is a block diagram showing a brief structure of a rubidium atomic oscillator of the present invention. This rubidium atomic oscillator 100 is provided with: a lamp excite section 1 which lights a rubidium lamp (hereinafter, referred to as “Rb lamp”) 5; the Rb lamp 5 which excites rubidium gas in a rubidium gas cell (hereinafter, referred to as “Rb gas cell”) 6; a lamp thermal cylinder (lamp holding member) 20 which holds and heats the Rb lamp 5; the Rb gas cell 6 in which rubidium atoms are encapsulated; a gas cell thermal cylinder (gas cell holding member) 30 which holds and heats the Rb gas cell 6; a temperature sensor (temperature detecting means) 14 which is sealed in a recessed part of the lamp thermal cylinder 20; a temperature sensor (temperature detecting means) 15 which is sealed in a recessed part of the gas cell thermal cylinder 30; a heater (heating means) 3 which heats the lamp thermal cylinder 20; a heater (heating means) 4 which heats the gas cell thermal cylinder 30; a temperature control section (temperature control means) 2 which maintains the heaters 3 and 4 at a predetermined temperature based on a temperature data detected by the temperature sensors 14 and 15; a photo-sensor 7 which detects intensity of light transmitting through the Rb gas cell 6; a phase discriminator 10 which discriminates a phase of low-frequency amplitude-modulated signal shown in an Amp 9; a low-frequency phase-modulated signal generator 11 which modulates a phase of microwave by low frequency; a frequency multiply-combine-modulate section 12 which multiplies an oscillation signal of a voltage controlled crystal oscillator 13 to microwave; the voltage controlled crystal oscillator 13 which oscillates predetermined frequency based on a voltage of the phase discriminator 10. Here, a unit including the Rb lamp 5, the Rb gas cell 6, and the photo-sensor 7 is called an optical microwave unit 8.

The description of the operation of the rubidium atomic oscillator is omitted here because it is known, while an outline of the optical microwave unit 8 which is a major element of this invention will be next described.

The gas cell thermal cylinder 30 holding the Rb gas cell 6 is provided with the heater 4 heating the gas cell thermal cylinder 30 and temperature-controlled by the temperature control section 2 and the temperature sensor 15, so that metal in the Rb gas cell 6 of the optical microwave unit 8 is prevented from being liquidized and disturbing the transmission of the rubidium light. An exterior wall of the circular cylinder (cavity) is wound with a c-field coil which is not shown and gives a magnetic field to the Rb gas cell 6 in a spiral manner so as to obtain turnover frequency of 6.834 GHz. Further, the lamp thermal cylinder 20 holding the Rb lamp 5 is provided with the heater 3 heating the lamp thermal cylinder 20 and temperature-controlled by the temperature control section 2 and the temperature sensor 14, so that the Rb lamp 5 of the optical microwave unit 8 exhibits sufficient excitation spectral intensity and is controlled to have a constant temperature of about 100 degrees Celsius.

### First Embodiment

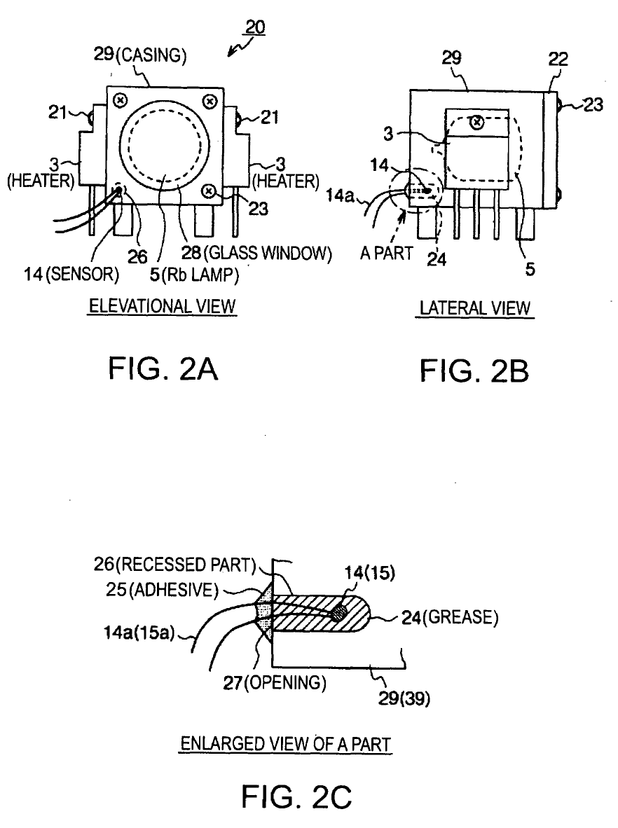

FIGS. 2A to 2C are schematic views showing a lamp thermal cylinder according to a first embodiment of the invention. Elements same as the ones in FIG. 1 are given the same reference numbers to be explained. FIG. 2A is an elevational view, FIG. 2B is a lateral view, and FIG. 2C is an enlarged view of A part of FIG. 2B. This lamp thermal cylinder 20 is provided with a casing 29 made of metal and having a cylindrical structure so as to house the Rb lamp 5 therein; a recessed part 26 provided on part of the surface of the casing 29; the temperature sensor 14 disposed in the recessed part 26; and grease 24 filling the recessed part 26 so as to cover and bury the temperature sensor 14. The recessed part 26 is formed in a bag shape from an opening 27 provided on the surface of the casing 29 toward the inside of the casing 29.

Further, on the elevational face of the casing 29, a lid 22 protecting the Rb lamp 5 is fixed by a screw 23, and to the lid 22, a glass window 28 for extracting light is provided. Further, a heater transistor (heater) 3 such as a three-terminal regulator is provided to be fixed at the both lateral faces of the casing 29 by the screw 21.

In the embodiment, the heater transistor 3 is provided to be fixed at the both lateral faces of the casing 29, but not limited. The heater transistor 3 may be provided on any places as long as the casing 29 has a small temperature gradient. Further, the transistor is used as the heater, but other heating elements are also available. The forming position of the recessed part 26 shown in the drawings is only an example. The recessed part 26 may be formed on other positions. Moreover, the size, the shape, and the depth of the recessed part 26 are not limited to the specific size, shape, and depth as long as the recessed part 26 is capable of housing the temperature sensor to cover and bury it by grease 24. However, it is understood that unmeaning enlargement of the shape or the depth increases consumed quantity of the grease 24 and produce disadvantageous cost of the elements, so that the minimum necessary size is preferable.

A method for sealing a temperature sensor of the embodiment will be next described with reference to the FIG. 2C. One method of the embodiment includes such processes that the recessed part 26 is filled with the grease 24 first; the temperature sensor 14 (15) is next buried in the grease 24; then a lead 14a (15a) taking a temperature data of the temperature sensor 14 (15) is extracted to the outside; and an opening 27 of the recessed part 26 is sealed with an adhesive 25 so as not to leak the grease 24. Another method includes such processes that the temperature sensor 14 (15) is provided in the recessed part 26 first, and the grease 24 is next provided.

The Rb lamp 5 needs to be maintained at constant temperature in order to stabilize the excitation of a rubidium atom. Therefore, the lamp thermal cylinder 20 is provided to hold the Rb lamp 5 therein. The lamp thermal cylinder 20 includes the transistor heater 3 heating the lamp thermal cylinder 20 and the temperature sensor 14 detecting the temperature of the lamp thermal cylinder 20. In order to increase the temperature detection sensitivity as much as possible, the embodiment fills the recessed part 26 provided to part of the lamp thermal cylinder 20 with the grease 24 and buries the temperature sensor 14 detecting the temperature of the lamp thermal cylinder 20 in the grease 24. The order of the processes may be exchanged. That is, the embodiment first disposes the temperature sensor 14 detecting the temperature of the lamp thermal cylinder 20 in the recessed part 26, and next fills the recessed part 26 with the grease 24, alternatively. These processes can improve the temperature detection responsiveness as much as possible, and prevent generation of air bubbles at the periphery of the temperature sensor 14.

Since the grease has higher fluidity than silicon rubber, it spreads into tiny spaces in the recessed part, thereby not generating vacancies or air bubbles between the temperature sensor and interior wall of the recessed part.

In addition, in order to detect the temperature of the lamp thermal cylinder 20 with high sensitivity, it is important to conduct the heat of the lamp thermal cylinder 20 to the temperature sensor 14 as fast as possible. Therefore, the grease 24 closely contacting the temperature sensor 14 needs to have high thermal conductivity. Using high thermal conductive silicon grease as the grease 24 can improve the conductivity of the heat. The grease is not limited to silicon grease, but may be non-silicon grease as long as it has sufficient fluidity and high thermal conductivity. Thus, the silicon grease has broad options.

Since the grease 24 filling the recessed part 26 does not harden due to its high fluidity, the opening 27 needs to be sealed after filling the recessed part 26 with the grease 24. The embodiment uses an adhesive 25 as a sealing member sealing the opening 27 of the recessed part. The adhesive 25 contacts the grease 24, so that the adhesive having high thermal conductivity is used here. This expands the whole conductive area. The lamp thermal cylinder 20 reaches extremely high temperature. Therefore, the adhesive having thermal resistance needs to be used as the adhesive 25 sealing the grease 24 so as not to transform or melt due to the heat.

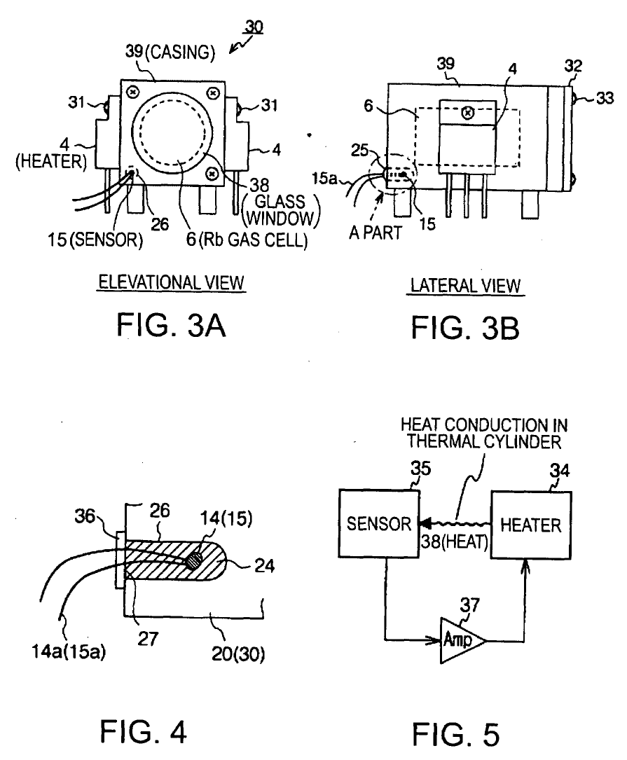

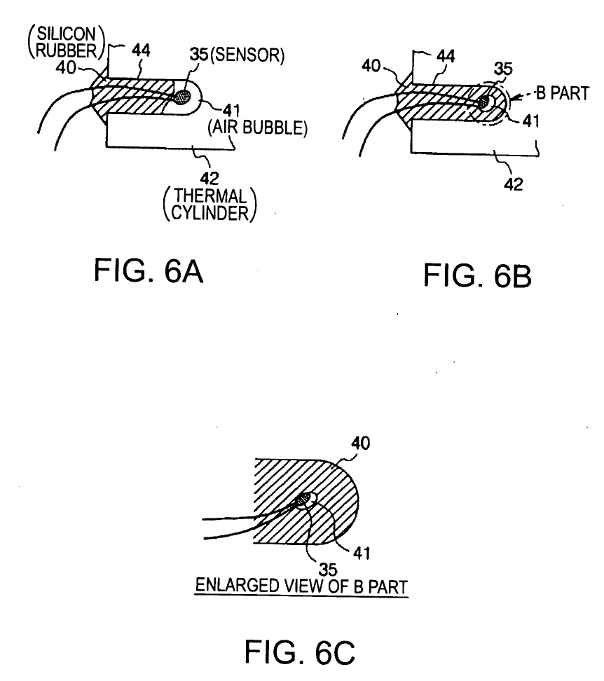

FIGS. 3A and 3B are schematic views showing a gas cell thermal cylinder according to the first embodiment of the invention. FIG. 3A is an elevational view, and FIG. 2B is a lateral view. Elements same as the ones in FIG. 1 are given the same reference numbers to be explained. Here, an enlarged view of A part of FIG. 3B is not shown because it is same as FIG. 2C. This gas cell thermal cylinder 30 is provided with a casing 39 made of metal and having a cylindrical structure so as to house the Rb gas cell 6 therein; the recessed part 26 provided on part of the surface of the casing 39; the temperature sensor 15 disposed in the recessed part 26; and the grease 24 filling the recessed part 26 so as to cover and bury the temperature sensor 15. The recessed part 26 is formed in a bag shape from the opening 27 provided on the surface of the casing 39 toward the inside of the casing 39.

Further, on the elevational face of the casing 39, a lid 32 protecting the Rb gas cell 6 is fixed by a screw 33, and to the lid 32, a glass window 38 for extracting light is provided. Thus, incident light from the front is transmitted to be detected its intensity by the photo-sensor 7. Further, a heater transistor (heater) 4 such as a three-terminal regulator is provided to be fixed on the both lateral faces of the casing 39 by the screw 31.

In the embodiment, the heater transistor 4 is provided on the both lateral faces of the casing 39, but not limited. The heater transistor 4 may be provided on any places as long as the casing 39 has a small temperature gradient. Further, the transistor is used as the heater, but other heating elements are also available. The forming position of the recessed part 26 shown in the drawings is only an example. The recessed part 26 may be formed on other positions. Moreover, the size, the shape, and the depth of the recessed part 26 are not limited to the specific size, shape, and depth as long as the recessed part 26 is capable of housing the temperature sensor to cover and bury it by grease 24. However, it is understood that unmeaning enlargement of the shape or the depth increases consumed quantity of the grease 24 and produce disadvantageous cost of the elements, so that the minimum necessary size is preferable.

Here, a description of a method for sealing the temperature sensor of the embodiment is omitted because it is same as the one shown in FIG. 2C.

The Rb gas cell 6 needs to be maintained at constant temperature in order to stabilize the excitation of a rubidium atom. Therefore, the gas cell thermal cylinder 30 is provided to hold the Rb gas cell 6 therein. The gas cell thermal cylinder 30 includes the transistor heater 4 heating the gas cell thermal cylinder 30 and the temperature sensor 15 detecting the temperature of the gas cell thermal cylinder 30. In order to increase the temperature detection sensitivity as much as possible, the embodiment fills the recessed part 26 provided to part of the gas cell thermal cylinder 30 with the grease 24 and buries the temperature sensor 15 detecting the temperature of the gas cell thermal cylinder 30 in the grease 24. The order of the processes may be exchanged. That is, the embodiment first disposes the temperature sensor 15 detecting the temperature of the gas cell thermal cylinder 30 in the recessed part 26, and next fills the recessed part 26 with the grease 24, alternatively. These processes improve the temperature detection responsiveness as much as possible, and prevent generation of air bubbles at the periphery of the temperature sensor 15.

In addition, in order to detect the temperature of the gas cell thermal cylinder 30 with high sensitivity, it is important to conduct the heat of the gas cell thermal cylinder 30 to the temperature sensor 15 as fast as possible. Therefore, the grease 24 closely contacting the temperature sensor 15 needs to have high thermal conductivity. Using high thermal conductive silicon grease as the grease 24 can improve the conductivity of the heat. The grease is not limited to silicon grease, but may be non-silicon grease as long as it has high thermal conductivity. Thus, the silicon grease has broad options.

Since the grease 24 filling the recessed part 26 does not harden due to its high fluidity, the opening 27 needs to be sealed after filling the recessed part 26 with the grease 24. The embodiment uses an adhesive 25 as a sealing member sealing the opening 27 of the recessed part. The adhesive 25 contacts the grease 24, so that the adhesive having high thermal conductivity is used here. This expands the whole conductive area. The gas cell thermal cylinder 30 reaches extremely high temperature. Therefore, the adhesive having thermal resistance needs to be used as the adhesive 25 sealing the grease 24 so as not to transform or melt due to the heat.

### Second Embodiment

FIG. 4 is a schematic view showing a recessed part sealed with a sealing member according to a second embodiment of the invention. Elements same as the ones in FIG. 2C are given the same reference numbers to be explained. The sealing member prevents the grease 24 from leaking to the outside. Therefore, a lid member 36 fitting the opening 27 of the recessed part 26 may be prepared so as to seal the grease 24 filling the recessed part 26. In the case, the lid member 36 is preferably made of high thermal conductive material. In addition, the gas cell thermal cylinder 30 reaches extremely high temperature. Therefore, the lid member 36 sealing the grease 24 needs to have at least thermal resistance so as not to transform or melt due to the heat.

FIG. 5 is a schematic diagram showing a common concept of negative feedback. Note that each element has a different reference number from the one in the above embodiments. A thermostat part of a rubidium atomic oscillator of the invention includes a temperature sensor 35 sealed by the method for sealing of the above embodiments, a heater 34, and an amplifier (temperature control means) 37. The amplifier 37 controls the heater 34 by a negative feedback system. That is, the temperature sensor 35 detects heat 38 of the heater 34, and, for example in a case using a thermocouple sensor, a voltage corresponding to the temperature is generated to be input into the amplifier 37. When the voltage rises over the voltage corresponding to the predetermined temperature, the amplifier 37 stops its output to stop the energization to the heater 34. Thus, the temperature of the heater 34 decreases spontaneously, varying the voltage of the temperature sensor 35. Then when the voltage falls below the voltage corresponding to the predetermined temperature, the amplifier 37 energizes the heater 34 to raise the temperature. Repeating these processes maintains the heater 34 at constant temperature.

1. An atomic oscillator, comprising:
a gas cell encapsulating a rubidium atom;
a gas cell holding member holding the gas cell;
a rubidium lamp exciting the rubidium atom in the gas cell;
a lamp holding member holding the rubidium lamp;
a temperature detecting means disposed in a recessed part provided to at least one of the gas cell holding member and the lamp holding member; and
grease closely contacting an exterior surface of the temperature detecting means disposed in the recessed part and burying the temperature detecting means therein.

2. The atomic oscillator according to claim 1, wherein the grease is high thermal conductive silicon grease.

3. The atomic oscillator according to claim 1, wherein the grease is high thermal conductive non-silicon grease.

4. The atomic oscillator according to claim 1, wherein an opening of the recessed part is sealed with a sealing member.

5. The atomic oscillator according to claim 4, wherein the sealing member is composed of high thermal conductive adhesive.

6. The atomic oscillator according to claim 4, wherein the sealing member is composed of thermal-resistant adhesive.

7. The atomic oscillator according to claim 4, wherein the sealing member is composed of a high thermal conductive lid member.

8. The atomic oscillator according to claim 4, wherein the sealing member is composed of a thermal-resistant lid member.

9. A method for sealing a temperature detecting means, wherein after the recessed part of claim 1 is filled with the grease of claim 1, the temperature detecting means of claim 1 is buried in the grease, and then the opening of the recessed part is sealed with a sealing member so as to prevent the grease from leaking.

10. The method for sealing a temperature detecting means, wherein after the temperature detecting means of claim 1 is disposed in the recessed part of claim 1, the recessed part is filled with the grease of claim 1 such that the grease closely contacts the exterior surface of the temperature detecting means, and then the opening of the recessed part is sealed with a sealing member so as to prevent the grease from leaking.

11. A rubidium atomic oscillator, comprising:
a temperature detecting means sealed in the recessed part by the method of claim 9;
a heating means heating at least one of the gas cell holding member and the lamp holding member; and
a temperature control means maintaining the heating means at a predetermined temperature based on a temperature data detected by the temperature detecting means, wherein
the temperature control means controls the heating means by a negative feedback system.
